(19) United States
(12) Patent Application Publication
(10) Pub. No.: US 2025/0262762 A1
(43) Pub. Date: Aug. 21, 2025

(54) ROBOT CONTROL METHOD AND SYSTEM BASED ON DEEP REINFORCEMENT LEARNING

(71) Applicant: SAMSUNG ELECTRONICS CO., LTD., Suwon-si (KR)

(72) Inventors: Changjoo Nam, Suwon-si (KR); Youngjoon Lee, Suwon-si (KR); Gyeonghwan Kim, Suwon-si (KR)

(73) Assignees: SAMSUNG ELECTRONICS CO., LTD., Suwon-si (KR); SOGANG UNIVERSITY RESEARCH FOUNDATION, Seoul (KR)

(21) Appl. No.: 18/970,284

(22) Filed: Dec. 5, 2024

(30) Foreign Application Priority Data
Feb. 15, 2024 (KR) 10-2024-0021999

(51) Int. Cl. B25J 9/16; B25J 9/00; B25J 19/02

(52) U.S. Cl. CPC B25J 9/163; B25J 9/0084; B25J 9/1664; B25J 19/021

(57) ABSTRACT

Provided is a system and method for controlling a robot. The method includes: training an agent through an actor-critic algorithm for deep reinforcement learning (DRL), wherein the training of the agent includes: identifying a robot cluster including a plurality of robots each configured to move from a starting point to a destination; obtaining initial state data from the robot cluster, wherein the initial state data includes information about a first location; sending, by an actor, an action to the robot cluster based on the initial state data; obtaining late state data from the robot cluster after the robot cluster has moved based on the action, wherein the late state data includes information about a second location reached by the robot cluster; and inputting a reward to a critic, wherein the reward is based on the initial state data and the late state data.

### CROSS-REFERENCE TO RELATED APPLICATION

This application is based on and claims priority to Korean Patent Application No. 10-2024-0021999, filed on Feb. 15, 2024, in the Korean Intellectual Property Office, the disclosure of which is incorporated by reference herein in its entirety.

### BACKGROUND

The disclosure relates to a robot control method and system based on deep reinforcement learning.

Recently, an increasing number of mobile robots have been deployed in living spaces. Mobile robots provide services, such as delivery, surveillance, and guidance. To provide these services, safe autonomous driving is essential in complex and crowded environments.

Most mobile robot autonomous driving methods include a global planner and a local planner/control policy. The global planner uses the global structure of an entire environment to generate a trajectory or a waypoint. Thereafter, the local planner or the control policy follows a global plan, avoiding collisions with unexpected, dynamic obstacles such as pedestrians.

For the local planner (or the control policy), approaches such as an artificial potential field and dynamic window access are widely used. However, most of these rule-based algorithms are known to have problems related to becoming caught in local minima, excessive dependence on accurate maps, lack of generalization in various environments, etc.

To overcome these problems, control approaches based on deep reinforcement learning (DRL) are suggested.

### SUMMARY

Provided is a robot control method based on deep reinforcement learning (DRL) with increased reliability.

Further, provided is a robot control system based on DRL with increased reliability.

The disclosure is not limited to the concepts mentioned above. The disclosure will be more clearly understood by one of skill in the art from the description below.

According to an aspect of the disclosure, a method of controlling a robot includes: training an agent through an actor-critic algorithm for deep reinforcement learning (DRL), wherein the training of the agent includes: identifying a robot cluster including a plurality of robots each configured to move from a starting point to a destination; obtaining initial state data from the robot cluster, wherein the initial state data includes information about a first location; sending, by an actor, an action to the robot cluster based on the initial state data; obtaining late state data from the robot cluster after the robot cluster has moved based on the action, wherein the late state data includes information about a second location reached by the robot cluster; and inputting a reward to a critic, wherein the reward is based on the initial state data and the late state data.

According to an aspect of the disclosure, a method of controlling a robot via a computer device including at least one processor includes: training, by the at least one processor, an agent through an actor-critic algorithm on a simulation for deep reinforcement learning, wherein the training of the agent includes: inputting initial state data and late state data to an actor network and inputting a reward to a critic network in the actor-critic algorithm, determining, by an evaluation network of the actor network, an action of the agent, and evaluating, by a value network of the critic network, a degree to which the action of the agent maximizes a preset reward, wherein the initial state data includes data about a first location of a robot cluster including a plurality of robots each configured to move from a starting point to a destination, wherein the late state data includes data about a second location reached by the robot cluster after the robot cluster has moved according to the action, and wherein the reward includes a value obtained by applying the initial state data and the late state data to a reward function.

According to an aspect of the disclosure, a robot control system includes: at least one memory storing one or more instructions; and at least one processor configured to execute the one or more instructions, wherein the one or more instructions, when executed by the at least one processor, are configured to cause the robot control system to train an agent through an actor-critic algorithm on a simulation for deep reinforcement learning (DRL) by: inputting initial state data and late state data to an actor network including an evaluation network, inputting a reward to a critic network of an actor-critic algorithm, the critic network including a value network, determining, by the evaluation network, an action of the agent, and evaluating, by the value network, a degree to which the action of the agent maximizes a preset reward, wherein the initial state data includes data about a first location of a robot cluster including a plurality of robots each configured to move from a starting point to a destination, wherein the late state data includes data about a second location reached by the robot cluster after the robot cluster has moved according to the action, and wherein the reward includes a value obtained by applying the initial state data and the late state data to a reward function.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a schematic block diagram of a robot control system according to an embodiment;

FIG. 2 is a flowchart of a robot control method according to an embodiment;

FIG. 3 is a schematic diagram illustrating an example of an environment as referenced in FIG. 1;

FIG. 4 is a schematic diagram illustrating a robot of a robot control system according to an embodiment;

FIGS. 5, 6, 7, 8, 9 and 10 are schematic diagrams illustrating a robot control method according to an embodiment;

FIGS. 11, 12, 13, 14 and 15 are schematic diagrams illustrating a robot control method according to embodiments;

FIG. 16 is a block diagram illustrating a computer device of a robot control system, according to an embodiment; and

FIGS. 17, 18 and 19 are diagrams illustrating environments and simulation results showing the effects of the one or more embodiments of the disclosure.

### DETAILED DESCRIPTION

Hereinafter, embodiments will be described with reference to the accompanying drawings. However, the disclosure should not be construed as being limited to the embodiments and may be embodied in other various forms. The embodiments are provided to fully convey the scope of the disclosure to those skilled in the art.

In the following description, like reference numerals refer to like elements throughout the specification. Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

It will be understood that when an element is referred to as being “connected” with or to another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

Herein, the expressions “at least one of a, b or c” and “at least one of a, b and c” indicate “only a,” “only b,” “only c,” “both a and b,” “both a and c,” “both b and c,” and “all of a, b, and c.”

It will be understood that, although the terms “first”, “second”, “third”, etc., may be used herein to describe various elements, is the disclosure should not be limited by these terms. These terms are only used to distinguish one element from another element.

As used herein, the singular forms “a,” “an” and “the” are intended to include the plural forms as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Mobile robots need to freely perform autonomous driving in complex and crowded environments to provide services to humans. For autonomous driving capability, deep reinforcement learning (DRL)-based methods have received attention.

It is required to successfully operate multiple robots in various fields, such as logistics, manufacturing, disaster response, and human environments. Mobility is one of the main capabilities required of robots to perform tasks. Robots need to navigate environments to reach their destinations, avoiding collision with obstacles and other nearby robots. For successful navigation, sub issues, such as control, detection, recognition, positioning, mapping, and path planning, need to be addressed. Multi-robot path planning (MRPP) needs to control multiple robots and is thus known to be computationally difficult to implement due to joint decision-making.

The disclosure considers the issue of MRPP in which robots need to move to their destinations without collisions. Typically, the issue has been solved using path finding methods. Path finding methods may guarantee collision-free paths but have some drawbacks for use in real-world environments.

Firstly, path-finding methods are often unsuitable for time-constrained tasks due to high computational complexity. Secondly, path-finding methods need to either discretize an environment into a grid or generate random configurations of robots from sampling. Accordingly, a grid space or a graph structure needs to be constructed to find a robot's path. In addition, without an infinite number of grids or samples, continuous space may not be fully utilized. Thirdly, path-finding methods need to consider dynamic constraints of robots when generating or following paths.

To overcome the aforementioned drawbacks of path-finding methods, the disclosure proposes a robot control method based on multi-agent reinforcement learning (MARL).

Robot control methods based on reinforcement learning (RL) do not require sequential processes of generating the structure of an environment, planning a path, resolving collisions between robots, and calculating robot control inputs. Therefore, RL-based robot control methods may quickly generate robot control inputs on time without delay. In addition, RL-based navigation methods may be universally applied to environments in which a starting point of a robot is different from a destination of the robot.

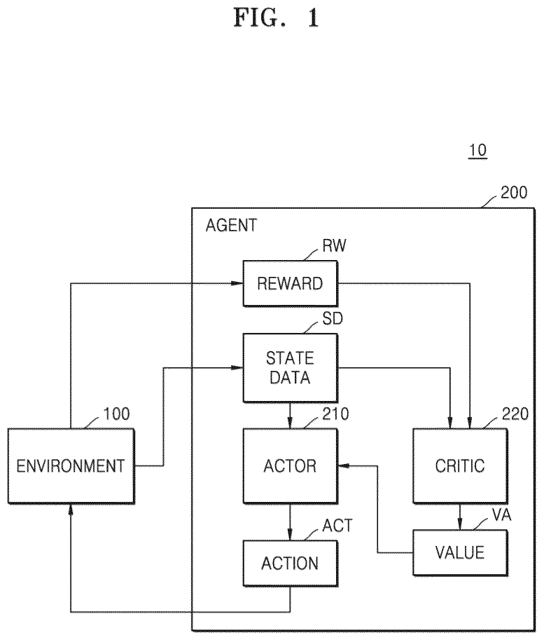

FIG. 1 is a schematic block diagram of a robot control system 10 according to an embodiment. Hereinafter, descriptions are made with reference to FIG. 1.

According to the disclosure, the robot control system 10 may include an agent 200 configured to control one or more robots operating in an environment 100. In the inventive concept, at least two robots are aimed at reaching a destination from a starting point in the environment 100 including obstacles. The at least two robots may learn one homogeneous policy, which may provide control inputs to a driving wheel of each robot to allow the robot to avoid collisions with obstacles and other robots and to navigate an environment. For a fast centralized training process, a limited amount of state data and actions are required. For this reason, a robot cluster consisting of three robots among multiple robots may be used.

In the environment 100, robots may transmit state data SD to an actor 210 and a critic 220 of the agent 200. The state data SD may include a top-view image of the environment 100, a current location of each of three robots constituting a robot cluster, the location of a destination, and a light detection and ranging (LiDAR) sensor reading. A shared policy of the robot cluster may be learned to maximize a reward RW accumulated based on the progress of navigation and collision. The shared policy may be learned when each robot acquires only the state data SD regarding robots belonging to the robot cluster, rather than information on all robots in the environment 100. When the state data SD that needs to be acquired by a robot is limited to the state data SD of the robot cluster consisting of three robots closest to each other, the shared policy may be more quickly learned compared to when the state data SD of more robots needs to be acquired.

The learned shared policy may be executed in a semi-decentralized manner. The semi-decentralized manner may allow each robot in the robot cluster to autonomously make decisions using the state data SD acquired by the robot and benefit from the collective state data SD of the other robots in the robot cluster. When the state data SD of each robot is combined with information sharing with the other robots in one robot cluster, navigation may be effectively accomplished in a multi-robot scenario.

As shown in FIG. 1, for example, reinforcement learning (RL) is a method allowing the agent 200 to learn a robot control method by itself while directly interacting with a simulation or the real world so as to maximize the reward RW designated by a developer, without a robot control algorithm made by humans. Deep reinforcement learning (DRL) refers to a model performing RL by using a deep neural network (DNN). At this time, the state data SD may refer to information transmitted to the agent 200 in the environment 100 that is given. An action ACT may refer to command data for allowing the actor 210 of the agent 200 to command robot clusters to act based on the state data SD. The reward RW may refer to immediate feedback from the environment 100 with respect to the action ACT that has been made. The agent 200 may learn a policy through the feedback.

The agent 200 may include the actor 210 and the critic 220. The actor 210 may output the action ACT with respect to the state data SD. The reward RW corresponding to evaluation of the action ACT output by the actor 210 may be input to the critic 220. In other words, the critic 220 may evaluate the worth of the action ACT output by the actor 210 through a value VA, and the worth of the action ACT output by the actor 210 may be updated through the value VA.

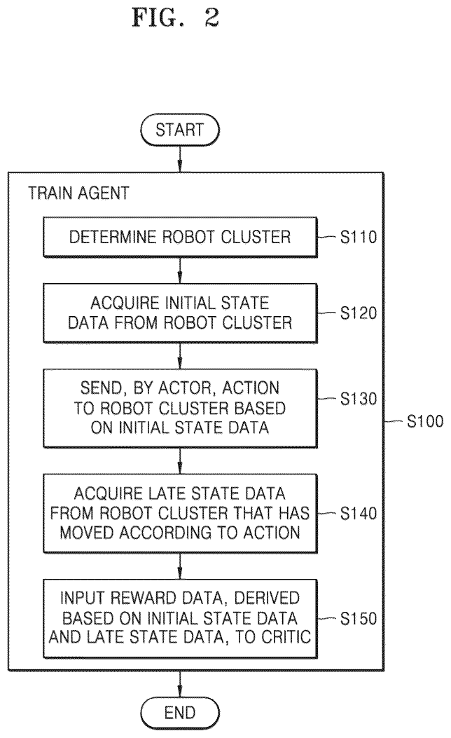

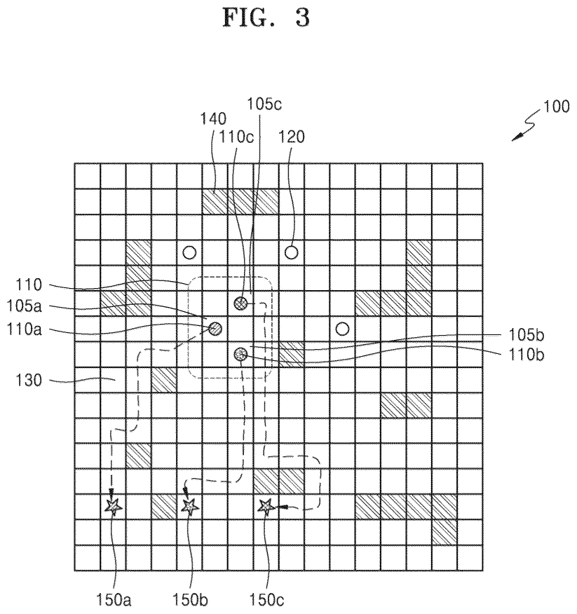

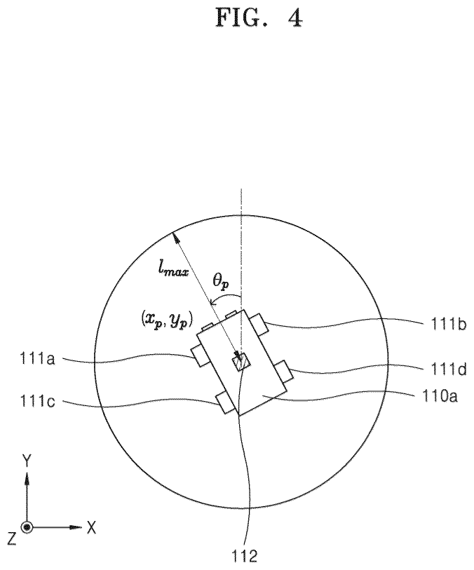

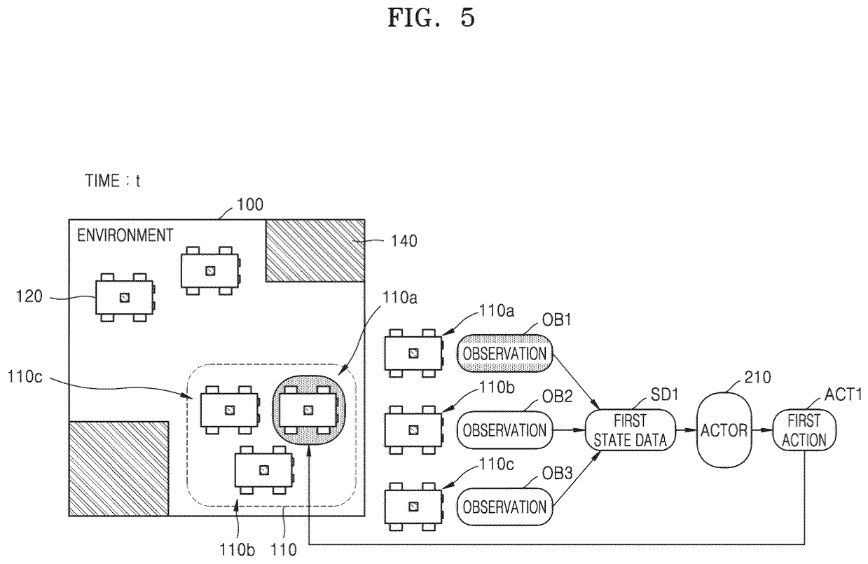

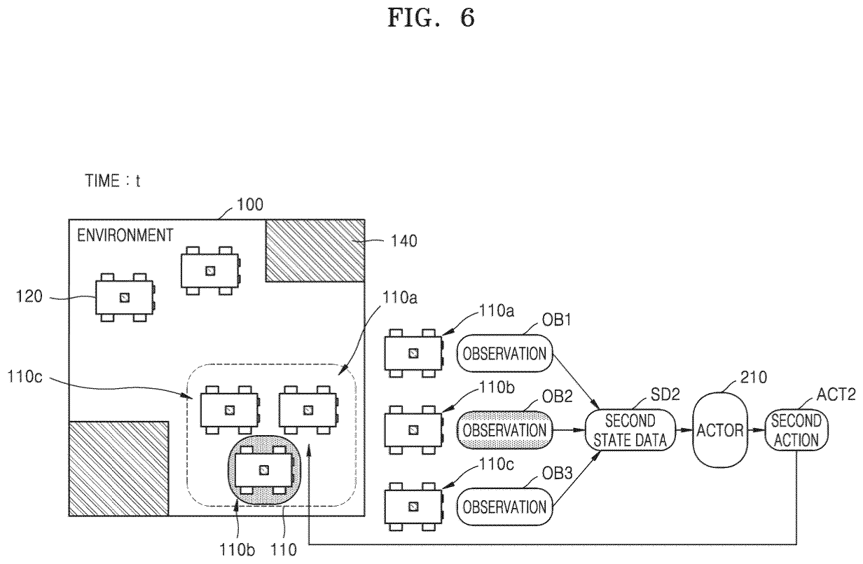

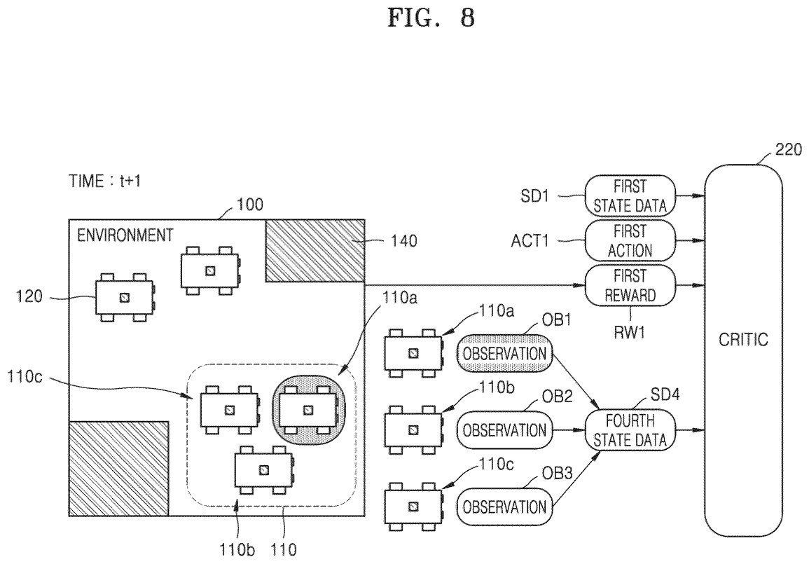

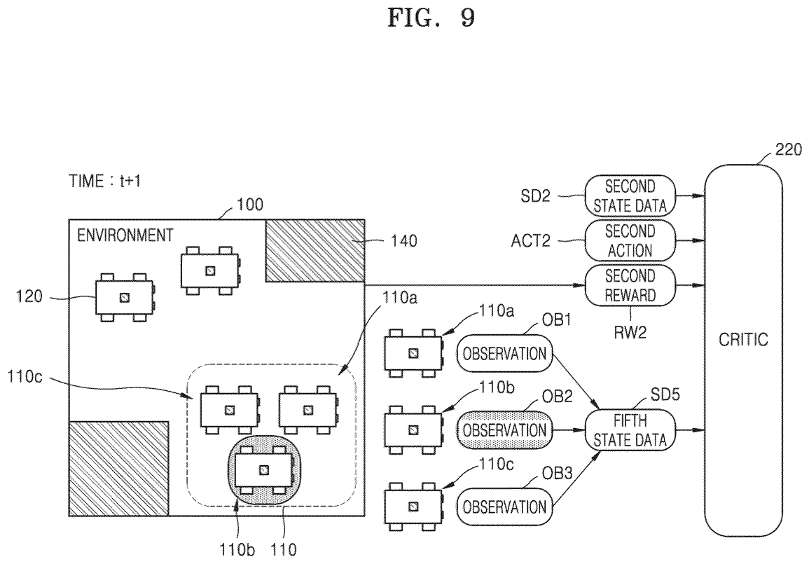

FIG. 2 is a flowchart of a robot control method according to an embodiment. FIG. 3 is a schematic diagram illustrating an example of the environment of FIG. 1. FIG. 4 is a schematic diagram illustrating a robot of a robot control system, according to an embodiment. FIGS. 5 to 10 are schematic diagrams illustrating a robot control method according to an embodiment. FIGS. 3 to 10 are described with reference to FIG. 2.

According to an embodiment, a robot control method includes training an agent through an actor-critic algorithm in a simulation for DRL in operation S100.

According to an embodiment, operation S100 may include identifying a robot cluster 110 consisting of some of a plurality of robots configured to move from starting points 105a, 105b, and 105c, respectively, to destinations 150a, 150b, and 150c, respectively, in operation S110. At this time, the robot cluster 110 may include three robots (e.g., 110a, 110b, and 110c) closest to each other among the plurality of robots in the environment 100. The plurality of robots may include three robots (e.g., 110a, 110b, and 110c) and other robots 120 that do not belong to the robot cluster 110. Three robots closest to each other may include a first robot 110a, a second robot 110b, and a third robot 110c. The first to third robots 110a, 110b, and 110c constituting the robot cluster 110 may acquire and store different state data (e.g., SD in FIG. 1). The state data is described below.

$$s = [ {s}^{{r}_{0}} . {s}^{{r}_{1}} , {s}^{{r}_{2}} , {s}^{I} ] \qquad Equation 1$$

In Equation 1, “s” denotes an entire state space of the first to third robots 110a, 110b, and 110c. The entire state space may include state data, s^{r}^{₀}, of the first robot 110a to be controlled, state data, s^{r}^{₁}, of the second robot 110b to be controlled, state data, s^{r}^{₂}, of the third robot 110c to be controlled, and a top-view image, s^{l}, of the environment 100.

$${s}^{r} = [ {s}_{l} , {s}_{p} , {s}_{v} , {s}_{g} ] \qquad Equation 2$$

In Equation 2, s^{T} denotes state data of each of the first to third robots 110a, 110b, and 110c. Here, Si denotes a LiDAR reading of each of the first to third robots 110a, 110b, and 110c. As shown in FIG. 4, each of the first to third robots 110a, 110b, and 110c may include a LiDAR sensor 112 and may determine whether there is an obstacle 140 within a maximum distance (e.g., lₘₐₓ) that may be sensed by the LiDAR sensor 112 in the radial direction thereof. For example, when there is an obstacle 140 within the sensing radius of the first robot 110a, the distance between the first robot 110a and the obstacle 140 may be derived (i.e., obtained) as a LiDAR sensor reading (e.g., sₗ). When there is no obstacle within the sensing radius of the first robot 110a, the maximum distance that may be sensed by the LiDAR sensor 112 may be output as a LiDAR sensor reading.

In Equation 2, sₚ denotes relative coordinates of the destinations 150a, 150b, and 150c from the current locations of the first to third robots 110a, 110b, and 110c. In Equation 2, s_{ν} denotes the velocity of each of the first to third robots 110a, 110b, and 110c and s_{g} denotes relative coordinates the destinations 150a, 150b, and 150c from the starting points 105a, 105b, and 105c of the first to third robots 110a, 110b, and 110c.

$${s}_{p} = [ {x}_{p} , {y}_{p} , {θ}_{p} ] \qquad Equation 3$$

In Equation 3, sₚ denotes relative coordinates of the destinations 150a, 150b, and 150c from the current locations of the first to third robots 110a, 110b, and 110c, xₚ denotes a coordinate on the X axis, yₚ denotes a coordinate on the Y axis, and θₚ may denote an angle between the Y axis and a direction in which each of the first to third robots 110a, 110b, and 110c is directed.

$${s}_{v} = [ {v}_{x} , {v}_{y} , {v}_{θ} ] \qquad Equation 4$$

In Equation 4, s_{ν} denotes the velocity of each of the first to third robots 110a, 110b, and 110c, νₓ denotes the linear velocity of each robot along the X axis, ν_{y} denotes the linear velocity of each robot along the Y axis, and ν_{θ} may denote the angular velocity of each robot.

In Equation 1, s′ denotes the top-view image of the environment 100. As shown in FIG. 3, the environment 100 may be implemented as a 16×16 pixel image. However, the pixel size of the environment 100 is just an example and the disclosure is not limited thereto. The top-view image of the environment 100 may include a space in which an obstacle 140 is located, a robot traveling space 130, the destinations 150a, 150b, and 150c, and spaces in which the first to third robots 110a, 110b, and 110c are respectively located. The spaces may be quantified as different weights. For example, the space in which the obstacle 140 is located may be quantified as 1, the robot traveling space 130 may be quantified as 0, each of the destinations 150a, 150b, and 150c may be quantified as 0.25, and each of the spaces in which the first to third robots 110a, 110b, and 110c are respectively located may be quantified as 0.5. In an embodiment, each of the first to third robots 110a, 110b, and 110c may determine the other robots as obstacles. For example, from the perspective of the first robot 110a, a space in which each of the second robot 110b and the third robot 110c is located may be quantified as 1. A space in which each of the other robots 120 that do not belong to the robot cluster 110 is located may also be quantified as 1. In other words, spaces where the movement of the first to third robots 110a, 110b, and 110c are oriented may be quantified as low weights. However, such quantification is just an example, and different numerical values may be defined according to embodiments.

According to an embodiment, operation S100, in which the agent is trained, may include acquiring initial state data from the robot cluster 110 in operation S120.

Referring to FIGS. 5 to 7, at a time “t”, the first to third robots 110a, 110b, and 110c in the robot cluster 110 may respectively acquire observation information OB1, observation information OB2, and observation information OB3, each including the location, velocity, and LiDAR sensor reading of each robot. First state data SD1, second state data SD2, and third state data SD3 may be constructed by combining the observation information OB1 acquired by the first robot 110a, the observation information OB2 acquired by the second robot 110b, and the observation information OB3 acquired by the third robot 110c. The first state data SD1, the second state data SD2, and the third state data SD3 that are acquired at the time “t” may be defined as initial state data. In the case of the first robot 110a, s^{r}^{₀} in Equation 1 may be defined as the first state data SD1 of the first robot 110a. In the case of the second robot 110b, s^{r}^{₀} in Equation 1 may be defined as the second state data SD2 of the second robot 110b. In the case of the third robot 110c, s^{r}^{₀} in Equation 1 may be defined as the third state data SD3 of the third robot 110c.

According to an embodiment, operation S100 may include operation S130 in which the actor 210 sends an action to the robot cluster 110 based on the initial state data. The actor 210 may output an action (e.g., ACT1, ACT2, and ACT3), which corresponds to command data for commanding the first to third robots 110a, 110b, and 110c to take actions, based on the initial state data (i.e., the first state data SD1, the second state data SD2, and the third state data SD3).

$$a = [ {v}_{FL} , {v}_{FR} , {v}_{RL} , {v}_{RR} ] \qquad Equation 5$$

Each of the first to third robots 110a, 110b, and 110c may have four wheels (e.g., 111a, 111b, 111c, and 111d in FIG. 4). In Equation 5, a denotes the action (e.g., ACT1, ACT2, and ACT3). The action includes a first action ACT1 sent to the first robot 110a, a second action ACT2 sent to the second robot 110b, and a third action ACT3 sent to the third robot 110c. Here, ν_{FL} denotes the velocity of a front left wheel 111a, ν_{FR} denotes the velocity of a front right wheel 111b, URL denotes the velocity of a rear left wheel 111c, and ν_{RR} denotes the velocity of a rear right wheel 111d. The actor 210 may send the first to third actions ACT1, ACT2, and ACT3 to the first to third robots 110a, 110b, and 110c, respectively, so that each of the first to third robots 110a, 110b, and 110c in the robot cluster 110 may control the velocity of the four wheels (111a, 111b, 111c, and 111d).

According to an embodiment, operation S100 may include acquiring late state data from the robot cluster 110, which has moved according to the action, in operation S140.

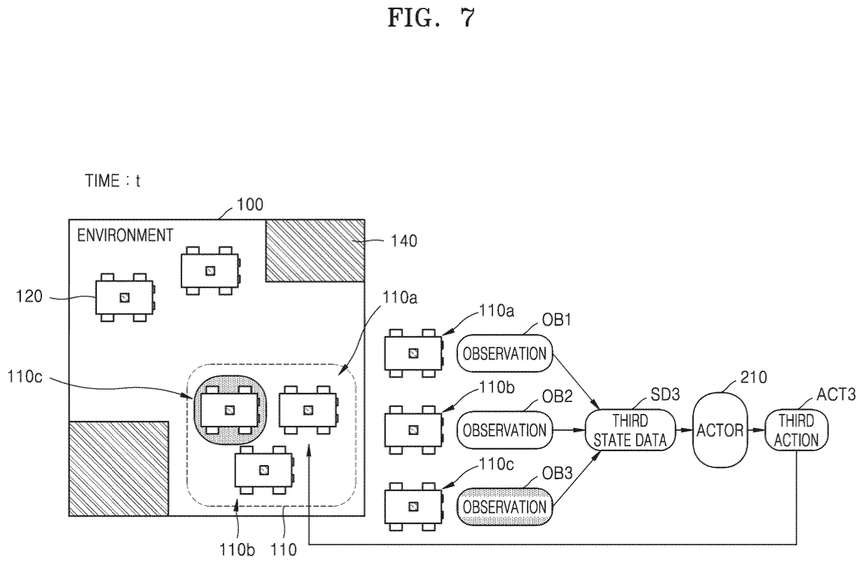

Referring to FIGS. 8 to 10, at a time t+1, each robot in the robot cluster 110 may acquire observation information including the location, velocity, and LiDAR sensor reading of the robot. At this time, observation information acquired by the first robot 110a, observation information acquired by the second robot 110b, and observation information acquired by the third robot 110c may be combined into state data. Fourth state data SD4, fifth state data SD5, and sixth state data SD6, which are acquired at the time t+1, may be defined as late state data. The late state data may include observation information, such as the location, velocity, and LiDAR sensor reading of the robot cluster 110 that has moved according to the action (ACT1, ACT2, and ACT3) of the actor 210. In the case of the first robot 110a at the time t+1, s^{r}^{₀} in Equation 1 may be defined as the fourth state data SD4 of the first robot 110a. In the case of the second robot 110b at the time t+1, s^{r}^{₀} in Equation 1 may be defined as the fifth state data SD5 of the second robot 110b. In the case of the third robot 110c at the time t+1, s^{r}^{₀} in Equation 1 may be defined as the sixth state data SD6 of the third robot 110c.

According to an embodiment, operation S100 may include inputting a reward, which is obtained based on the initial state data and the late state data, to the critic 220 in operation S150.

Here, the reward may correspond to a result value obtained from a preset reward function using the initial state data and the late state data as variables. The reward may include a goal value, a penalty value, and a leading value.

$${r}_{g}^{t} = \{ \begin{matrix}{r}_{goal} , if reaching a destination \\ 0 , in otherwise cases\end{matrix} \qquad Equation 6$$

Referring to Equation 6, r_{g}^{t} denotes the goal value. When it is determined from the late state data that a plurality of robots (e.g., 110a, 110b, and 110c) constituting the robot cluster 110 have arrived at their destinations, the goal value may be defined as r_{goal}. Otherwise, when it is determined from the late state data that a plurality of robots (e.g., 110a, 110b, and 110c) constituting the robot cluster 110 have not yet arrived at their destinations, the goal value may be defined as 0. In an embodiment, r_{goal} may be defined as 10. However, these numerical values are just examples, and embodiments are not limited thereto.

$${r}_{c}^{t} = \{ \begin{matrix}- {r}_{col} * {e}^{- {w}_{i} * {s}_{{I}_{min}}} , if {s}_{{l}_{min}} \leq {l}_{c} \\ 0 , in otherwise cases\end{matrix} \qquad Equation 7$$

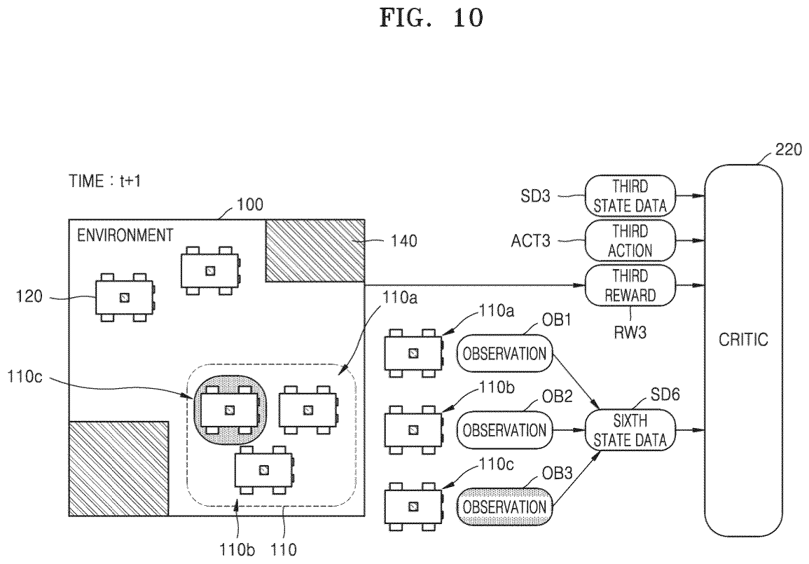

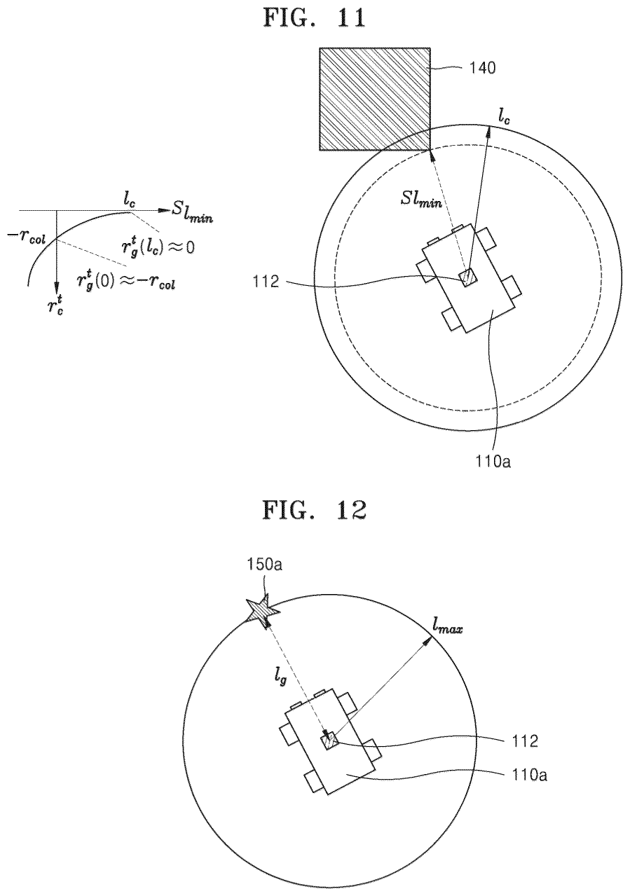

FIG. 11 is a schematic conceptual diagram illustrating Equation 7. Descriptions below are made with reference to FIG. 11 and Equation 7. Although the first robot 110a is illustrated in FIG. 11 for convenience of description, the descriptions below are not limited to the first robot 110a and may be applied to all robots (e.g., 110a, 110b, and 110c) deployed in an environment. In Equation 7, r_{c}^{t} denotes a penalty value. The penalty value may be a compensation for a collision of the first robot 110a with the obstacle 140 and may indicate a reward obtained when the first robot 110a approaches the obstacle 140 within a certain distance. In Equation 7, r_{col} is a parameter and denotes the maximum limit of the penalty value. In Equation 7, sim denotes the distance between the first robot 110a and the obstacle 140 and l_{c} denotes the maximum distance that may be sensed by the LiDAR sensor 112 of the first robot 110a in the radial direction thereof. In Equation 7, wᵢ is a coefficient for adjusting the weight of r_{c}^{t} with respect to sₗ_{ₘᵢₙ}.

In the graph in FIG. 11, the vertical axis is the penalty value (e.g., r_{c}^{t}) and the horizontal axis is the distance (e.g., sₗ_{ₘᵢₙ}) between the first robot 110a and the obstacle 140 when the distance (e.g., sₗ_{ₘᵢₙ}) between the first robot 110a and the obstacle 140 is less than or equal to the maximum distance (e.g., l_{c}) that may be sensed by the LiDAR sensor 112 of the first robot 110a in the radial direction thereof. Here, as the distance between the first robot 110a and the obstacle 140 decreases, the penalty value may exponentially increase toward −r_{col} to the maximum. As the distance between the first robot 110a and the obstacle 140 increases, the penalty value may exponentially decrease toward 0. Accordingly, the penalty value as a reward may be output as a negative value as the distance between the first robot 110a and the obstacle 140 decreases.

In an embodiment, r_{col} may be defined as 0.5 and wᵢ may be defined as 30. In addition, l_{c}, may be defined as 0.15. However, these numerical values are just examples, and embodiments are not limited thereto.

$$Equation 8$$

$${r}_{d}^{t} = \{ \begin{matrix}{w}_{d} \frac{{‖ {d}^{t - 1} - {d}^{t} ‖}_{1}}{{‖ {d}^{0} ‖}_{1}} , if {l}_{g} = {l}_{max} or {l}_{g} < {l}_{max} and {l}_{g} \geq {‖ {d}^{t - 1} ‖}_{2} \\ {w}_{f} * {l}_{mov} , if {l}_{g} < {l}_{max} and {l}_{g} \geq {‖ {d}^{t - 1} ‖}_{2}\end{matrix}$$

FIGS. 12 to 14 are schematic conceptual diagrams illustrating Equation 8. Descriptions below are made with reference to FIGS. 12 to 14 and Equation 8. Although the first robot 110a is illustrated in FIGS. 12 to 14 for convenience of description, the descriptions below are not limited to the first robot 110a and may be applied to all robots (e.g., 110a, 110b, and 110c) deployed in an environment. In Equation 8, r_{d}^{t} denotes a leading value. The leading value is aimed at deriving a method of going around an obstacle rather than simply getting closer to the destination 150a when the obstacle is between the first robot 110a and the destination 150a. The leading value may be effectively used when the destination 150a is within a range that may be sensed by the LiDAR sensor 112 of the first robot 110a.

In Equation 8, ∥d⁰∥₁ denotes the distance between the starting point 105a (in FIG. 1) and the destination 150a. In Equation 8, ∥d^{t-1}−d^{t}∥₁ denotes the difference between the distance between the first robot 110a and the destination 150a at a time t-1 and the distance between the first robot 110a and the destination 150a at the time “t”, and lₘₐₓ denotes the maximum distance that may be sensed by the LiDAR sensor 112 of the first robot 110a in the radial direction thereof. In Equation 8, l_{g} denotes a LiDAR sensor reading sensed by the LiDAR sensor 112 of the first robot 110a within the maximum sensing radius thereof. Accordingly, when the obstacle 140 is within the maximum sensing radius of the LiDAR sensor 112 of the first robot 110a, l_{g} is the distance between the first robot 110a and the obstacle 140. When the obstacle 140 is not within the maximum sensing radius of the LiDAR sensor 112 of the first robot 110a, l_{g} is lₘₐₓ. In Equation 8, w_{d} is a coefficient for adjusting the weight of a value obtained by dividing ∥d^{t-1}−d^{t}∥₁ by ∥d⁰∥₁ for r_{d}^{t}.

In Equation 8, lₘₒᵥ denotes a LiDAR sensor reading sensed by the LiDAR sensor 112 of the first robot 110a in a direction in which the first robot 110a travels. In Equation 8, w_{f} is a coefficient for adjusting the weight of lₘₒᵥ for r_{d}^{t}.

FIG. 12 is a diagram illustrating a leading value obtained when the obstacle 140 is not within the maximum sensing radius of the LiDAR sensor 112 of the first robot 110a. When the obstacle 140 is not within the maximum sensing radius of the LiDAR sensor 112 of the first robot 110a, a LiDAR sensor reading (e.g., l_{g}) may be the maximum distance (e.g., lₘₐₓ) that may be sensed by the LiDAR sensor 112 of the first robot 110a in the radial direction thereof. At this time, the leading value may be proportional to a value obtained by dividing ∥d^{t-1}−d^{t}∥₁ by ∥d⁰∥₁. In other words, the leading value may increase as the first robot 110a moves in a direction, in which ∥d^{t-1}−d^{t}∥₁ increases, over time (for example, as “t” increases).

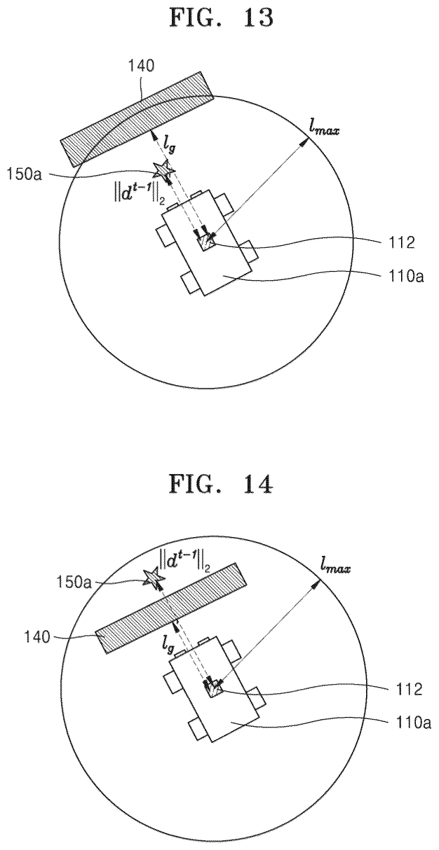

FIG. 13 is a diagram illustrating the leading value obtained when the obstacle 140 is within the maximum sensing radius of the LiDAR sensor 112 of the first robot 110a and the destination 150a is between the first robot 110a and the obstacle 140. In other words, a LiDAR sensor reading (e.g., l_{g}) sensed by the LiDAR sensor 112 of the first robot 110a within the maximum sensing radius of the LiDAR sensor 112 of the first robot 110a is less than the distance (e.g., ∥d^{t-1}∥) between the first robot 110a and the destination 150a at the time t-1.

When the obstacle 140 is within the maximum sensing radius of the LiDAR sensor 112 of the first robot 110a and the destination 150a is between the first robot 110a and the obstacle 140, the first robot 110a may continuously move toward the destination 150a. Accordingly, the leading value may be proportional to a value obtained by dividing ∥d^{t-1}−d^{t}∥₁ by ∥d⁰∥₁. In other words, the leading value may increase as the first robot 110a moves in the direction in which ∥d^{t-1}−d^{t}∥₁ increases over time (i.e., as “t” increases).

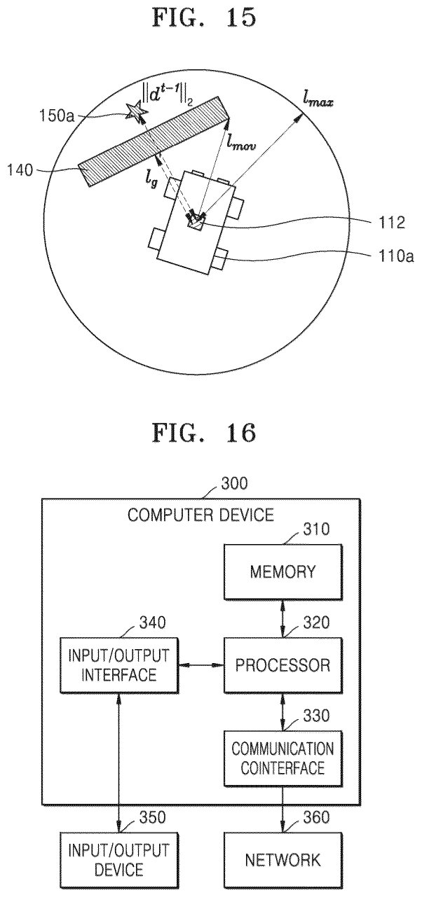

FIGS. 14 and 15 are diagrams illustrating the leading value obtained when the destination 150a is within the maximum sensing radius of the LiDAR sensor 112 of the first robot 110a and the obstacle 140 is between the first robot 110a and the destination 150a. In other words, a LiDAR sensor reading (e.g., l_{g}) sensed by the LiDAR sensor 112 of the first robot 110a within the maximum sensing radius of the LiDAR sensor 112 of the first robot 110a is greater than or equal to the distance (e.g., ∥d^{t-1}∥) between the first robot 110a and the destination 150a at the time t-1 and is less than the maximum distance (e.g., lₘₐₓ) that may be sensed by the LiDAR sensor 112 in the radial direction thereof.

In this case, the first robot 110a may need to go around the obstacle 140 rather than moving forward to the destination 150a. Accordingly, as shown in FIG. 15, the leading value may increase as the LiDAR sensor reading (e.g., lₘₒᵥ), which is sensed by the LiDAR sensor 112 of the first robot 110a in a direction in which the first robot 110a travels, increases. Accordingly, the first robot 110a may go around the obstacle 140 such that the LiDAR sensor reading (e.g., lₘₒᵥ), which is sensed by the LiDAR sensor 112 of the first robot 110a in the direction in which the first robot 110a travels, increases.

In an embodiment, w_{d} may be defined as 10 and w_{f} may be defined as 0.0005. However, these numerical values are just examples, and the disclosure is not necessarily limited thereto.

FIG. 16 is a block diagram of an example of a computer device according to an embodiment. For example, an agent training method according to embodiments may be performed by a computer device 300 in FIG. 16.

Referring to FIG. 16, the computer device 300 may include a memory 310, a processor 320, a communication interface 330, and an input/output interface 340. The memory 310 may be a computer-readable recording medium and may include random access memory (RAM), read-only memory (ROM), or a permanent mass storage device such as a disk drive. Here, ROM or a permanent mass storage device such as a disk drive may be included in the computer device 300 as a permanent storage device separate from the memory 310. An operating system (OS) and at least one piece of program code may be stored in the memory 310. These software components may be loaded from a computer-readable recording medium of another computer to the memory 310. The computer-readable recording medium of another computer may include a floppy drive, a disc, tape, a digital versatile disc (DVD)/CD-ROM drive, or a memory card. In one or more embodiments, the software components may be loaded to the memory 310 through the communication interface 330 rather than from a computer-readable recording medium. For example, the software components may be loaded to the memory 310 of the computer device 300 based on a computer program installed by files received through a network 360.

The processor 320 may be configured to process instructions of a computer program by performing basic arithmetic, logic, and input/output operations. Instructions may be provided to the processor 320 through the memory 310 or the communication interface 330. For example, the processor 320 may be configured to execute the received instructions according to program code stored in a recording device such as the memory 310.

The communication interface 330 may provide a function allowing the computer device 300 to communicate with other devices (e.g., the storage devices described above) through the network 360. For example, a request, a command, data, a file, or the like, which the processor 320 of the computer device 300 generates according to the program code stored in a recording device such as the memory 310, may be transmitted to other devices through the network 360 under control by the communication interface 330. Signals, commands, data, files, or the like from other devices may be received by the computer device 300 through the network 360 and the communication interface 330 of the computer device 300. Signals, command, or data, which are received through the communication interface 330, may be transmitted to the processor 320 or the memory 310. Files or the like received through the communication interface 330 may be stored in a storage medium (e.g., a permanent storage device) that may be further included in the computer device 300.

The input/output interface 340 may interface with an input/output device 350. For example, an input device may include a microphone, a keyboard, a mouse, or the like. An output device may include a display, a speaker, or the like. As another example, the input/output interface 340 may interface with a device, such as a touch screen, which combines an input function with an output function. The input/output device 350 may be integrated with the computer device 300.

In one or more embodiments, the computer device 300 may include more or less components than those in FIG. 16. However, most components according to the related art may not be clearly illustrated. For example, the communication interface 330 may include at least part of the input/output device 350 or may further include other components such as a transceiver and a database.

Communication methods are not limited. As well as communication methods using communication networks (e.g., mobile communication networks, wired Internet, wireless Internet, and broadcasting networks) that may be included in the network 360, short-range wireless communications, such as Bluetooth and near field communication (NFC), may be used. For example, the network 360 may include at least one selected from the group consisting of a personal area network (PAN), a local area network (LAN), a campus area network (CAN), a metropolitan area network (MAN), a wide area network (WAN), a broadband network (BBN), and the Internet. The network 360 may include at least one selected from the group consisting of a bus network, a star network, a ring network, a mesh network, a star-bus network, and a network topology including a tree or hierarchical network but is not limited thereto.

The agent training method according to the present embodiment may be performed by, for example, the computer device 300. The processor 320 of the computer device 300 may be configured to execute control instructions according to the code of an OS or at least one program, which is included in the memory 310. Here, the processor 320 may control the computer device 300 to perform operations S110 to S150 in the method of FIG. 2 according to the control instructions, which the code stored in the computer device 300 provides. Basically, the computer device 300 may train an agent through an actor-critic algorithm on a simulation for DRL.

For example, in the actor-critic algorithm, the computer device 300 may input first information to an actor network, which is an evaluation network determining an action of an agent, and input second information to a critic network, which is a value network evaluating how helpful the action of the agent is in maximizing a preset reward. Here, the second information may include the first information and additional information. For example, referring to FIGS. 5 and 8, the first information may include the first state data SD1 of the first robot 110a and the additional information may include the first action ACT1, a first reward RW1, and the fourth state data SD4.

As a specific embodiment of agent training, operations S110 to S150 in FIG. 2 may be performed by the computer device 300.

According to the disclosure, a robot control method based on DRL may receive information (such as an environment image, a LiDAR measurement value, and robot states) about an environment and robots and generate a control input for a wheel of each of the robots through RL. Here, the robots may learn one homogeneous policy. For more coordinated navigation, centralized learning that uses information of two closest robots as state data may be required. Each robot may recognize the other robots as dynamic obstacles, navigate a dynamic environment, and collect episodes each consisting of a state including the observations of the closest robots, an action, and a reward. Through this, a DRL-based robot control method with increased reliability may be provided.

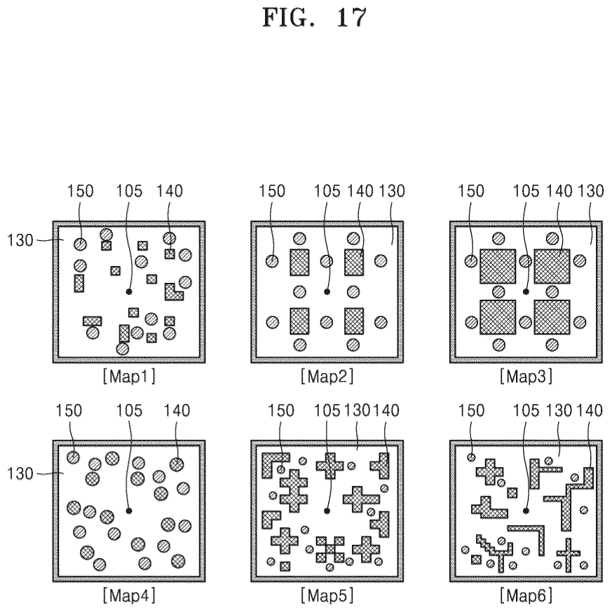

FIGS. 17 to 19 are diagrams illustrating environments and simulation results showing the effects of the disclosure.

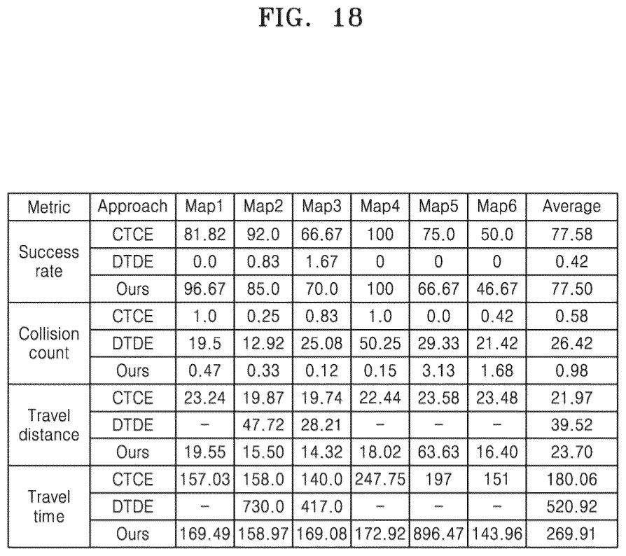

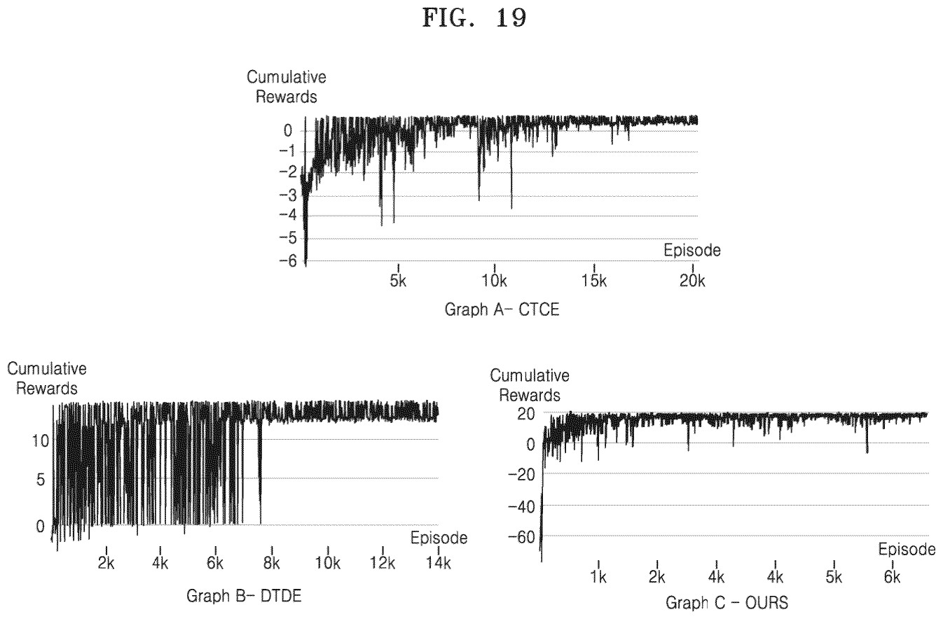

FIG. 17 illustrates the maps of six environments, wherein each map may include a starting point 105, a traveling space 130, an obstacle 140, and a destination 150. FIGS. 18 and 19 show the results of simulations in the maps of six environments in FIG. 17. In particular, FIGS. 18 and 19 show simulation results comparing the disclosure with a decentralized training and decentralized execution (DTDE) approach and a centralized training and centralized execution (CTCE) approach. Descriptions below are made with reference to FIGS. 17 to 19.

In the table of FIG. 18, a policy may be learned using one agent with respect to each robot in the DTDE approach. At this time, the learned policy may be applied to each robot through an individual actor corresponding to the robot. In the CTCE approach, the policy may be learned using one agent for all three robots in a centralized manner. At this time, the learned policy may be applied to all robots through a single actor.

In each map, robots are directed to move toward twelve random destinations 150. To evaluate average performance in each map, fifty tests may be repeated. At this time, a travel distance and a travel time may be calculated only in successful tests. Accordingly, in the DTDE approach, a travel distance and a travel time may not be displayed because a success rate is 0 in most simulation environments.

As may be seen from the table of FIG. 18, the robot control method proposed by the disclosure may have increased reliability compared to the DTDE approach. Compared to the DTDE approach, the success rate increases and the collision count decreases in the disclosure. The travel distance in the disclosure is shorter than that in the DTDE approach, and thus, the travel time is also reduced.

A simulation process was continued until the success rate converged to 100%. In other words, the simulation process was terminated when each robot was able to arrive at its destination with high reliability. In the graphs in FIG. 19, the horizontal axis indicates the number of episodes performed until the success rate converged to 100% and the vertical axis indicates cumulative rewards. That the cumulative rewards on the vertical axis converge to a particular number means that the success rate converges to 100%. As may be seen from FIG. 19, the robot control method of the disclosure may achieve faster convergence throughout the simulation process compared to the CTCE approach and the DTDE approach. While 10,000 or more simulation episodes were needed until the success rates continuously converged to 100% in the CTCE approach and the DTDE approach, the success rate quickly converged to 100% after 2,000 or more simulation episodes in robot control method of the disclosure.

As described above, according to embodiments, in a simulation for DRL, information that is difficult to acquire in the real world but helpful for learning may be directly extracted from the state of the simulation and is provided to a value network among the value network and the policy network of an actor-critic algorithm. Accordingly, the value of an action of an agent may be accurately evaluated in the value network used during the learning, thereby increasing the performance of the policy network. In addition, when the agent is allowed to acquire information about an environment outside the current field of vision through a previous sensor value, which is stored in a recurrent neural network, by using memory, such as long-short term memory (LSTM), of the recurrent neural network, even the agent having the limited field of vision may efficiently perform autonomous driving.

The system or device described above may be implemented by a hardware component or a combination of a hardware component and a software component. For example, the device and the component, which have been described in the embodiments, may be implemented using at least one general-use computer or special-purpose computer, like a processor, a controller, an arithmetic logic unit (ALU), a digital signal processor, a microcomputer, a field programmable gate array (FPGA), a programmable logic unit (PLU), a microprocessor, or any other device that can execute and respond an instruction. A processing device may run an OS and at least one software application executed on the OS. A processing device may access, store, handle, process, and generate data in response to the execution of software. To promote understanding, it has been described in some cases that a single processing device is used, but it will be understood by one of ordinary skill in the art that a processing device may include a plurality of processing elements and/or a multi-type processing element. For example, a processing device may include a plurality of processors or a single processor and a single controller. In addition, a different configuration like a parallel processor may be used.

Software may include a computer program, code, instructions, or a combination of at least one of them, and may configure a processing device to operate as desired or may independently or collectively instruct a processing device. Software and/or data may be embodied in a certain type of machine, a component, a physical device, virtual equipment, or a computer storage medium or device such that a processing device analyzes the software and/or the data or is provided with an instruction or data. Software can also be distributed over network-coupled computer systems so that the software is stored and executed in a distributed manner. Software and data may be stored in at least one computer-readable recording medium.

The method according to embodiments may be embodied as program instructions executable using various computer devices and recorded on a computer-readable recording medium. The computer-readable recording medium may have recorded thereon a program instruction, a data file, a data structure, or a combination thereof. A medium may continuously store a computer-executable program or temporarily store a computer-executable program for execution or download. The medium may include various recording units or storage units, each including a single hardware component or several hardware components, and is not limited to a medium directly connected to a computer system and may be distributed over a network. Examples of the medium include magnetic media (e.g., hard disks, floppy disks, and magnetic tapes), optical media (e.g., CD-ROMs and DVDs), magneto-optical media (e.g., floptical disks), and hardware devices (e.g., ROM, RAM, and flash memory) that are configured to store program instructions. Examples of the medium may also include a recording medium or a storage medium, which is managed by app stores distributing applications, sites supplying or distributing various types of software, and servers. Examples of the program instructions include machine code created by a compiler and high-level language code that can be executed in a computer using an interpreter.

While the disclosure has been particularly shown and described with reference to embodiments thereof, it will be understood that various changes in form and details may be made therein without departing from the spirit and scope of the following claims.

What is claimed is:

1. A method of controlling a robot, the method comprising:
training an agent through an actor-critic algorithm for deep reinforcement learning (DRL), wherein the training of the agent comprises:
identifying a robot cluster comprising a plurality of robots each configured to move from a starting point to a destination;
obtaining initial state data from the robot cluster, wherein the initial state data comprises information about a first location;
sending, by an actor, an action to the robot cluster based on the initial state data;
obtaining late state data from the robot cluster after the robot cluster has moved based on the action, wherein the late state data comprises information about a second location reached by the robot cluster; and
inputting a reward to a critic, wherein the reward is based on the initial state data and the late state data.

2. The method of claim 1, wherein the robot cluster comprises three robots closest to each other from among the plurality of robots.

3. The method of claim 1, wherein the reward comprises a value obtained by applying the initial state data and the late state data to a reward function.

4. The method of claim 3, wherein the reward function comprises a goal value comprising information about whether each robot of the robot cluster arrives at the destination, a penalty value comprising information about whether each robot of the robot cluster is in a vicinity of an obstacle, and a leading value for obtaining a different value according to a positional relation between the destination and the obstacle.

5. The method of claim 4, wherein, based on the late state data comprising information indicating that the robot cluster has not arrived at the destination, the goal value is 0.

6. The method of claim 4, wherein, based on the late state data comprising information indicating that the robot cluster is in the vicinity of the obstacle, the penalty value is a negative number and an absolute value of the penalty value increases as a distance between the robot cluster and the obstacle decreases.

7. The method of claim 4, wherein,
based on the late state data comprising information indicating that the robot cluster is closer to the destination than to the obstacle, the leading value is a first positive number, and
based on the late state data comprising information indicating that the robot cluster is closer to the obstacle than to the destination, the leading value is a second positive number that is smaller than the first positive number.

8. The method of claim 7, wherein an absolute value of the first positive number increases as the robot cluster gets closer to the destination.

9. The method of claim 1, wherein the initial state data further comprises light detection and ranging (LiDAR) sensing information and location information of the robot cluster obtained before the robot cluster moves based on the action.

10. The method of claim 1, wherein the late state data further comprises light detection and ranging (LiDAR) sensing information and location information of the robot cluster obtained after the robot cluster has moved based on the action.

11. The method of claim 1, wherein the action comprises information about a rotation speed of a wheel of each robot of the robot cluster.

12. A method of controlling a robot via a computer device including at least one processor, the method comprising:
training, by the at least one processor, an agent through an actor-critic algorithm on a simulation for deep reinforcement learning, wherein the training of the agent comprises:
inputting initial state data and late state data to an actor network and inputting a reward to a critic network in the actor-critic algorithm,
determining, by an evaluation network of the actor network, an action of the agent, and
evaluating, by a value network of the critic network, a degree to which the action of the agent maximizes a preset reward,
wherein the initial state data comprises data about a first location of a robot cluster including a plurality of robots each configured to move from a starting point to a destination,
wherein the late state data comprises data about a second location reached by the robot cluster after the robot cluster has moved according to the action, and
wherein the reward comprises a value obtained by applying the initial state data and the late state data to a reward function.

13. The method of claim 12,
wherein the initial state data further comprises first location information of the robot cluster at the first location and first light detection and ranging (LiDAR) sensing information, and
wherein the late state data further comprises second location information of the robot cluster at the second location and second LiDAR sensing information.

14. The method of claim 13, wherein each of the first LiDAR sensing information and the second LiDAR sensing information comprises information about whether there is an object within a certain distance from the robot cluster.

15. The method of claim 12,
wherein the reward function comprises a goal value comprising information about whether each of robot of the robot cluster arrives at the destination, a penalty value comprising information about whether each robot of the robot cluster is in a vicinity of an obstacle, and a leading value for obtaining a different value according to a positional relation between the destination and the obstacle, and
wherein, based on the late state data comprising information indicating that the robot cluster has arrived at the destination, the goal value is 10.

16. The method of claim 15,
wherein, based on the late state data comprising information indicating that the robot cluster is in the vicinity of the obstacle, the penalty value is defined as rt=−0.5*e^{-30*s}^{ₗ},
where r_{c}^{t} denotes the penalty value and sₗ denotes a distance between the robot cluster and the obstacle.

17. The method of claim 15,
wherein, based on the late state data comprising information indicating that the robot cluster is closer to the destination than to the obstacle, the leading value is defined as
$${r}_{d}^{t} = 10 * \frac{‖ {d}^{t - 1} - {d}^{t} ‖}{‖ {d}^{0} ‖} ,$$
where r_{d}^{t} denotes the leading value, d⁰ denotes a distance between the starting point and the destination, d^{t-1} denotes a distance between the first location and the destination, and d^{t} denotes a distance between the second location and the destination.

18. The method of claim 15,
wherein, based on the late state data comprising information indicating that the robot cluster is closer to the obstacle than to the destination, the leading value is defined as
$${r}_{d}^{t} = 0.0005 * {l}_{mov} ,$$
where r_{d}^{t} denotes the leading value and lₘₒᵥ denotes light detection and ranging sensing information in a direction in which the robot cluster moves.

19. A method of controlling a robot via a computer device including at least one processor, the method comprising:
training, by the at least one processor, an agent through an actor-critic algorithm on a simulation for deep reinforcement learning, wherein the training of the agent comprises:
inputting initial state data and late state data to an actor network and inputting a reward to a critic network in the actor-critic algorithm;
determining, by an evaluation network of the actor network, an action of the agent; and
evaluating, by a value network of the critic network, a degree to which the action of the agent maximizes a preset reward,
wherein the initial state data comprises data about a first location of a robot cluster including a plurality of robots each configured to move from a starting point to a destination,
wherein the late state data comprises data about a second location reached by the robot cluster after the robot cluster has moved according to the action,
wherein the reward comprises a value obtained by applying the initial state data and the late state data to a reward function,
wherein the reward function comprises a goal value comprising information about whether each robot of the robot cluster arrives at the destination, a penalty value comprising information about whether each robot of the robot cluster is in a vicinity of an obstacle, and a leading value for obtaining a different value according to a positional relation between the destination and the obstacle,
wherein, based on the late state data comprising information indicating that the robot cluster has arrived at the destination, the goal value is 10,
wherein, based on the late state data comprising information indicating that the robot cluster is in the vicinity of the obstacle, the penalty value is defined as r_c\hat{ }t=−0.5*e\hat{ }(−30*s_l),
where rct denotes the penalty value and sl denotes a distance between the robot cluster and the obstacle, and
wherein, based on the late state data comprising information indicating that the robot cluster is closer to the destination than to the obstacle, the leading value is defined as
$$r\_d \hat{} t = 10 * ‖ d \hat{} ( t - 1 ) - d \hat{} t ‖ / ‖ d \hat{} 0 ‖ ,$$
where rdt denotes the leading value, d0 denotes a distance between the starting point and the destination, dt-1 denotes a distance between the first location and the destination, and dt denotes a distance between the second location and the destination.

20. The method of claim 19,
wherein, based on the late state data comprising information indicating that the robot cluster is closer to the obstacle than to the destination, the leading value is defined as
$$r\_d \hat{} t = 0.0005 * 1 \_mov ,$$
where rdt denotes the leading value and lₘₒᵥ denotes light detection and ranging sensing information in a direction in which the robot cluster moves.
